(19) United States
(12) Patent Application Publication
(10) Pub. No.: US 2023/0215132 A1
(43) Pub. Date: Jul. 6, 2023

(54) METHOD FOR GENERATING RELIGHTED IMAGE AND ELECTRONIC DEVICE

(71) Applicant: BEIJING BAIDU NETCOM SCIENCE TECHNOLOGY CO., LTD., Beijing (CN)

(72) Inventors: Fu Li, Beijing (CN); Hao Sun, Beijing (CN)

(73) Assignee: BEIJING BAIDU NETCOM SCIENCE TECHNOLOGY CO., LTD., Beijing (CN)

(21) Appl. No.: 18/183,439

(22) Filed: Mar. 14, 2023

Related U.S. Application Data
(63) Continuation of application No. PCT/CN2022/088031, filed on Apr. 20, 2022.

(30) Foreign Application Priority Data
Jun. 29, 2021 (CN) 202110729941.9

(51) Int. Cl. G06V 10/60; G06T 3/40; G06T 5/50; G06V 10/44; G06V 10/62; G06V 10/74

(52) U.S. Cl. CPC G06V 10/60; G06T 3/40; G06T 5/50; G06V 10/44; G06V 10/62; G06V 10/761; G06T 2207/20221

(57) ABSTRACT

A method for generating a relighted image includes: obtaining a to-be-processed image and a guidance image corresponding to the to-be-processed image; obtaining a first intermediate image consistent with an illumination condition in the guidance image by performing relighting rendering on the to-be-processed image in a time domain based on the guidance image; obtaining a second intermediate image consistent with the illumination condition in the guidance image by performing relighting rendering on the to-be-processed image in a frequency domain based on the guidance image; and obtaining a target relighted image corresponding to the to-be-processed image based on the first intermediate image and the second intermediate image.

### CROSS-REFERENCE TO RELATED APPLICATION

This application is a continuation of International Patent Application No. PCT/CN2022/088031 filed on Apr. 20, 2022, which is based upon and claims a priority to Chinese Patent Application No. 202110729941.9, filed with China National Intellectual Property Administration on Jun. 29, 2021, the entire contents of which are incorporated herein by reference for all purposes.

### FIELD

The present disclosure relates to the field of computer technologies, and more particularly to the field of artificial intelligence, further to computer vision and deep learning technologies, and is applicable to an image processing scene.

### BACKGROUND

With the rapid development of mobile terminal technologies and image processing technologies, various applications (APP) with special effects based on relighting technologies emerge as the times require. Further, users place increasing demands for adding a filter, changing a face shadow effect and other functions to an image, for example, demands for accurately performing a relighting process on an image to be processed according to a guidance image, even under a condition that an illumination direction and a color temperature are unknown.

In the related art, following two ways are generally employed to generate a relighted image. One is manual rendering, and the other one is applying a model for relighting rendering on the image to be processed, which is obtained from neural network learning and training.

However, for the manual rendering, there are some problems such as a high labor cost, a low efficiency and a poor reliability in a procedure for generating the relighted image; for the network obtained by the neural network learning and training, there are problems, such as the relighted image generated having artifacts, and inability to learn shadow changes.

Therefore, there is still a need to improve validity and reliability of the method for generating the relighted image.

### SUMMARY

According to a first aspect of the present disclosure, a method for generating a relighted image is provided. The method includes: obtaining a to-be-processed image and a guidance image corresponding to the to-be-processed image; obtaining a first intermediate image consistent with an illumination condition in the guidance image by performing relighting rendering on the to-be-processed image in a time domain based on the guidance image; obtaining a second intermediate image consistent with the illumination condition in the guidance image by performing relighting rendering on the to-be-processed image in a frequency domain based on the guidance image; and obtaining a target relighted image corresponding to the to-be-processed image based on the first intermediate image and the second intermediate image.

According to a second aspect of the present disclosure, a method for training a relighted image generation system is provided. The method includes: obtaining a to-be-processed sample image provided with a marked target relighted image and a sample guidance image corresponding to the to-be-processed sample image; obtaining a first loss function by inputting the to-be-processed sample image and the sample guidance image into a time-domain feature obtaining model of a to-be-trained relighted image generation system for training; obtaining a second loss function by inputting the to-be-processed sample image and the sample guidance image into a frequency-domain feature obtaining model of the to-be-trained relighted image generation system for training; and obtaining a total loss function for the to-be-trained relighted image generation system based on the first loss function and the second loss function, adjusting a model parameter of the to-be-trained relighted image generation system based on the total loss function to obtain a training result, returning to the step of obtaining the to-be-processed sample image provided with the marked target relighted image and the sample guidance image corresponding to the to-be-processed sample image until the training result meets a training end condition, and determining the to-be-trained relighted image generation system subjected to a last adjustment of the model parameter as a trained relighted image generation system.

According to a third aspect of the present disclosure, an apparatus for generating a relighted image is provided. The apparatus includes: a first obtaining module, configured to obtain a to-be-processed image and a guidance image corresponding to the to-be-processed image; a second obtaining module, configured to obtain a first intermediate image consistent with an illumination condition in the guidance image by performing relighting rendering on the to-be-processed image in a time domain based on the guidance image; a third obtaining module, configured to obtain a second intermediate image consistent with the illumination condition in the guidance image by performing relighting rendering on the to-be-processed image in a frequency domain based on the guidance image; and a fourth obtaining module, configured to obtain a target relighted image corresponding to the to-be-processed image based on the first intermediate image and the second intermediate image.

According to a fourth aspect of the present disclosure, an apparatus for training a relighted image generation system is provided. The apparatus includes: a first obtaining module, configured to obtain a to-be-processed sample image provided with a marked target relighted image and a sample guidance image corresponding to the to-be-processed sample image; a second obtaining module, configured to obtain a first loss function by inputting the to-be-processed sample image and the sample guidance image into a time-domain feature obtaining model of a to-be-trained relighted image generation system for training; a third obtaining module, configured to obtain a second loss function by inputting the to-be-processed sample image and the sample guidance image into a frequency-domain feature obtaining model of the to-be-trained relighted image generation system for training; and a determining module, configured to obtain a total loss function for the to-be-trained relighted image generation system based on the first loss function and the second loss function, adjust a model parameter of the to-be-trained relighted image generation system based on the total loss function to obtain a training result, return to the step of obtaining the to-be-processed sample image of the marked target relighted image and the sample guidance image corresponding to the to-be-processed sample image until the training result meets a training end condition, and to determine the to-be-trained relighted image generation system subjected to a last adjustment of the model parameter as a trained relighted image generation system.

According to a fifth aspect of the present disclosure, an electronic device is provided. The electronic device includes: at least one processor and a memory. The memory is communicatively coupled to the at least one processor. The memory is configured to store instructions executable by the at least one processor. The at least one processor is configured to execute the method for generating the relighted image as described in the first aspect of the present disclosure or the method for training the relighted image generation system as described in the second aspect of the present disclosure when the instructions are executed by the at least one processor.

According to a sixth aspect of the present disclosure, a non-transitory computer-readable storage medium having computer instructions stored thereon is provided. The computer instructions are configured to cause a computer to execute the method for generating the relighted image as described in the first aspect of the present disclosure or the method for training the relighted image generation system as described in the second aspect of the present disclosure.

According to a seventh aspect of the present disclosure, a computer program product including a computer program is provided. The method for generating the relighted image as described in the first aspect of the present disclosure or the method for training the relighted image generation system as described in the second aspect of the present disclosure is implemented when the computer program is processed by a processor.

### BRIEF DESCRIPTION OF THE DRAWINGS

The accompanying drawings are used for better understanding the embodiments and do not constitute a limitation of the present disclosure.

FIG. 1 is a flow chart of a method for generating a relighted image according to an embodiment of the present disclosure.

FIG. 2 is a schematic diagram illustrating a procedure for generating a relighted image.

FIG. 3 is a flow chart of a method for generating a relighted image according to a further embodiment of the present disclosure.

FIG. 4 is a flow chart of obtaining a first intermediate image according to an embodiment of the present disclosure.

FIG. 5 is a flow chart of obtaining a first scene content feature image and a first lighting feature image according to an embodiment of the present disclosure.

FIG. 6 is a schematic diagram illustrating a procedure for processing a first feature image according to an embodiment of the present disclosure.

FIG. 7 is a flow chart of a method for generating a relighted image according to a further embodiment of the present disclosure.

FIG. 8 is a schematic diagram illustrating a to-be-processed image according to an embodiment of the present disclosure.

FIG. 9 is a schematic diagram illustrating results of performing DWT on a to-be-processed image according to an embodiment of the present disclosure.

FIG. 10 is a flow chart of obtaining a second intermediate image according to an embodiment of the present disclosure.

FIG. 11 is a flow chart of relighting rendering by a wavelet transformation model according to an embodiment of the present disclosure.

FIG. 12 is a flow chart of preprocessing an image according to an embodiment of the present disclosure.

FIG. 13 is a schematic diagram illustrating a procedure for generating a relighted image according to an embodiment of the present disclosure.

FIG. 14 is a schematic diagram illustrating a procedure for generating a relighted image according to another embodiment of the present disclosure.

FIG. 15 is a schematic diagram illustrating a procedure for generating a relighted image according to a further embodiment of the present disclosure.

FIG. 16 is a flow chart of a method for training a relighted image generation system according to an embodiment of the present disclosure.

FIG. 17 is a flow chart of a method for training a relighted image generation system according to another embodiment of the present disclosure.

FIG. 18 is a flow chart of obtaining a first loss function according to an embodiment of the present disclosure.

FIG. 19 is a flow chart of obtaining a second loss function according to an embodiment of the present disclosure.

FIG. 20 is a block diagram illustrating an apparatus for generating a relighted image according to an embodiment of the present disclosure.

FIG. 21 is a block diagram illustrating an apparatus for generating a relighted image according to another embodiment of the present disclosure.

FIG. 22 is a block diagram illustrating an apparatus for training a relighted image generation system according to an embodiment of the present disclosure.

FIG. 23 is a block diagram illustrating an apparatus for training a relighted image generation system according to another embodiment of the present disclosure.

FIG. 24 is a block diagram illustrating an electronic device according to an embodiment of the present disclosure.

### DETAILED DESCRIPTION

Description will be made below to embodiments of the present disclosure with reference to accompanying drawings, which includes various details of embodiments of the present disclosure to facilitate understanding and should be regarded as merely examples. Therefore, it should be recognized by the skilled in the art that various changes and modifications may be made to the embodiments described herein without departing from the scope and spirit of the present disclosure. Meanwhile, for clarity and conciseness, descriptions for well-known functions and structures are omitted in the following description.

Brief description will be made below to technical fields related in the embodiments of the present disclosure.

Computer technologies, including extensive contents, can be roughly divided into several aspects such as computer system technologies, computer device technologies, computer component technologies and computer assembly technologies. Computer technologies include: a basic principle of an operation method, a design of an arithmetic unit, an instruction system, a central processing unit (CPU) design, a pipeline principle, application of the pipeline principle in the CPU design, a storage system, a bus, and input and output.

Artificial intelligence (AI) is a subject that focuses on simulating thought processes and intelligent behaviors (such as learning, reasoning, thought, and planning) on behalf of a human being. The artificial intelligence relates to both hardware and software technologies. The hardware technologies of the artificial intelligence include some aspects such as computer vision technologies, speech recognition technologies, natural language processing technologies and learning/deep learning, big data processing technologies, and knowledge map technologies.

Computer vision is a science that studies how to enable machines to “see”, and further refers to perform machine vision, such as recognition, tracking and measurement, on a target by cameras and computers instead of human eyes, and further performs image processing, to enable the target through computer processing to become an image more suitable for human eyes to observe or transmission to instruments for detection. As a scientific subject, the computer vision studies related theories and technologies, and tries to establish an artificial intelligence system that may obtain “information” from images or multidimensional data. The information here may refer to information defined by Shannon and configured to help make a “decision”. Because perception may be regarded as extracting information from a sensory signal, the computer vision may also be regarded as a science for studying how to enable the artificial intelligence system to “perceive” from the images or the multidimensional data.

Deep learning (DL) is a new study direction in the field of machine learning (ML). Deep learning is introduced into the machine learning to make it closer to the original goal—the artificial intelligence. Deep learning is to learn an inherent law and a representation hierarchy of sample data. Information obtained during the deep learning process is helpful to interpretation of data such as characters, images and sounds. An ultimate goal of the deep learning is to enable machines to have an ability to analyze and learn like human beings, and to recognize data such as characters, images and sounds. The deep learning is a complex machine learning algorithm, and has achieved far more results in speech and image recognition than previously related technologies.

Description will be made below to a method and an apparatus for generating a relighted image, and an electronic device according to embodiments of the present disclosure with reference to accompanying drawings.

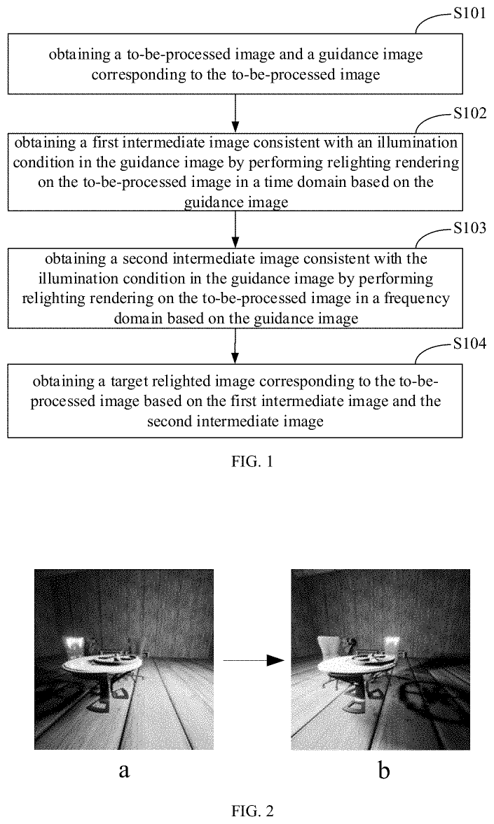

FIG. 1 is a flow chart of a method for generating a relighted image according to an embodiment of the present disclosure. It should be noted that, an entity for executing a method for generating a relighted image according to embodiments is an apparatus for generating a relighted image. The apparatus for generating the relighted image may be a hardware device, or software in the hardware device. The hardware device may be, such as a terminal device, or a server.

As illustrated in FIG. 1, the method for generating the relighted image according to embodiments includes the following operations.

At block S101, a to-be-processed image and a guidance image corresponding to the to-be-processed image are obtained.

The to-be-processed image may be any image inputted by the user. For example, an image obtained by performing decoding and frame extracting on a video such as a teaching video, a movie or a TV dramas may be taken as the to-be-processed image.

It should be noted that, when trying to obtain the to-be-processed image, an image pre-stored in local or in a remote storage region may be taken as the to-be-processed image, or an image captured directly is taken as the to-be-processed image.

Optionally, the to-be-processed image may be obtained from images or videos stored in at least one of an image library and a video library in the local or in the remote storage region. Optionally, an image captured directly may be taken as the to-be-processed image. A way of obtaining the to-be-processed image is not limited in embodiments of the present disclosure, which may be selected based on an actual situation.

The guidance image may be an image with an arbitrary illumination condition and is used for guiding the rendering on the to-be-processed image.

At block S102, a first intermediate image consistent with an illumination condition in the guidance image is obtained by performing relighting rendering on the to-be-processed image in a time domain based on the guidance image.

At block S103, a second intermediate image consistent with the illumination condition in the guidance image is obtained by performing relighting rendering on the to-be-processed image in a frequency domain based on the guidance image.

It should be noted that, in the related art, the relighting processing is performed on the to-be-processed image based on manual rendering, or based on a model for performing relighting rendering on the to-be-processed image, such as a convolutional neural network (CNN) model obtained from neural network learning and training.

However, for the manual rendering, there are some problems such as a high labor cost, a low efficiency and a poor reliability in a procedure for generating the relighted image. Generally, a network obtained based on the neural network learning and training only corresponds to the time domain, that is, relighting processing is performed on an RGB image directly. In this case, there will be problems, such as the relighted image generated having artifacts, and inability to learn shadow changes due to defects in the network design.

Therefore, with the method for generating the relighted image according to the present disclosure, a better quality relighting mage may be generated by performing relighting rendering on the to-be-processed image, and by performing the operation on a time domain image and a frequency domain image.

Relighting refers to changing a lighting direction and a color temperature of a given image to generate an image with different lighting direction and color temperature.

For example, as illustrated in FIG. 2, an image (a) is a scene image having a color temperature value of 2500K and a light source from the east, and an image (b) is a scene image having a color temperature value of 6500K and a light source from the west. It can be noted that, an image color is close to yellow when the color temperature value is low, which belongs to a warm tone, and the image color is close to white when the color temperature value is high, which belongs to a cool tone. At the same time, the light sources at different positions may cause different shadows. In conclusion, relighting rendering refers to rendering the image (a) to generate the image (b), and scene content in the image (a) is consistent with that in the image (b), only the color temperature and the shadow direction are changed.

At block S104, a target relighted image corresponding to the to-be-processed image is obtained based on the first intermediate image and the second intermediate image.

In embodiments of the present disclosure, after the first intermediate image and the second intermediate image are obtained, the first intermediate image and the second intermediate image may be processed in multiple ways to obtain the target relighted image corresponding to the to-be-processed image.

It should be noted that, a detailed way for obtaining the target relighted image corresponding to the to-be-processed image is not limited in the present disclosure, and may be selected based on an actual situation. For example, the first intermediate image and the second intermediate image may be weighted to obtain a weighted result, and the weighted result may be taken as the target relighted image. For another example, the first intermediate image and the second intermediate image may be averaged to obtain an average value, and the average value may be taken as the target relighted image.

With the method for generating the relighted image according to embodiments of the present disclosure, the relighted image is generated without the manual design or the convolution neural network model obtained according to the neural network learning and training. Relighting rendering is performed on the to-be-processed image and the guidance image in the time domain and in the frequency domain. For the target relighted image obtained from the relighting technology, the scene content structure at the low frequency and detailed shadow information at the high frequency are retained according to feature information in the time domain and in the frequency domain. In this way, the target relighted image with an accurate and reliable rendering effect is realized.

FIG. 3 is a flow chart of a method for generating a relighted image according to a further embodiment of the present disclosure.

As illustrated in FIG. 3, the method for generating the relighted image according to embodiments includes the following operations.

At block S301, a to-be-processed image and a guidance image corresponding to the to-be-processed image are obtained.

The description at block S301 is the same as that at block S101 in the above embodiment, which is not elaborated herein.

The detailed operation for obtaining the first intermediate image consistent with the illumination condition in the guidance image by performing relighting rendering on the to-be-processed image in the time domain based on the guidance image at block S102 in the above embodiment includes the following operation at block S302.

At block S302, the first intermediate image consistent with the illumination condition in the guidance image is obtained by inputting the to-be-processed image and the guidance image into a time-domain feature obtaining model of a relighted image generation system for relighting rendering in the time domain.

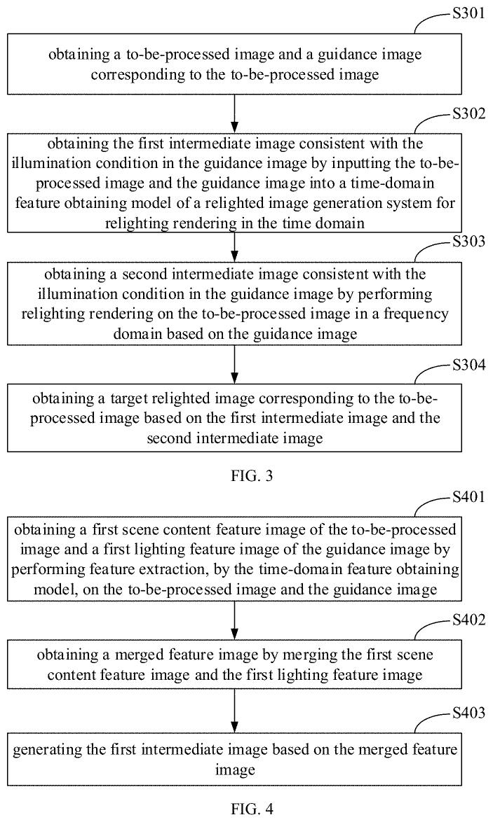

In an embodiment, as illustrated in FIG. 4, on the basis of the above embodiments, the detailed operation for obtaining the first intermediate image consistent with the illumination condition in the guidance image by inputting the to-be-processed image and the guidance image into the time-domain feature obtaining model of the relighted image generation system for relighting rendering in the time domain at block S302 includes the following operation.

At block S401, a first scene content feature image of the to-be-processed image and a first lighting feature image of the guidance image are obtained by performing feature extraction, by the time-domain feature obtaining model, on the to-be-processed image and the guidance image.

In an embodiment, as illustrated in FIG. 5, on the basis of the above embodiments, the detailed operation for obtaining the first scene content feature image of the to-be-processed image and the first lighting feature image of the guidance image by performing feature extraction, by the time-domain feature obtaining model, on the to-be-processed image and the guidance image includes the following operation.

At block S501, a first feature image of the to-be-processed image and a first feature image of the guidance image are obtained by performing downsampling, by the time-domain feature obtaining model, on the to-be-processed image and the guidance image, respectively.

In embodiments of the present disclosure, the to-be-processed image and the guidance image may be downsampled by the time-domain feature obtaining model. Optionally, convolution processing may be performed on the to-be-processed image and the guidance image to obtain convolved images. Normalization processing is performed on the convolved images to obtain normalized images. Further, nonlinearization processing is performed on the normalized images to increase the image nonlinearity. Further, in each downsampling, after the nonlinearization processing, pooling processing may be performed on a feature image to obtain the first feature image.

It should be noted that, in the present disclosure, pool processing is to process a local part. Optionally, the feature image obtained after the nonlinearization processing may be divided into a plurality of small local blocks. An average value or a maximum value of pixel values in each local block may be taken as a value of the local block.

For example, in a case that both a width and a height of each small local block are 2, both the width and the height of the feature image may be reduced by a factor of 2 after pooling processing. Because the value of each small local block is merely related to the small local block and has nothing to do with other small local blocks, this operation is local processing.

At block S502, the first scene content feature image of the to-be-processed image and the first lighting feature image of the guidance image are obtained by performing division processing on the first feature image of the to-be-processed image and the first feature image of the guidance image, respectively.

In embodiments of the present disclosure, the first feature image may be divided into two parts in a channel dimension.

It should be noted that, since the first feature images refer to the first feature image of the to-be-processed image and the first feature image of the guidance image, the first scene content feature image and a first lighting feature image of the to-be-processed image and the first lighting feature image and a first scene content feature image of the guidance image are obtained after division processing is performed on the first feature images respectively.

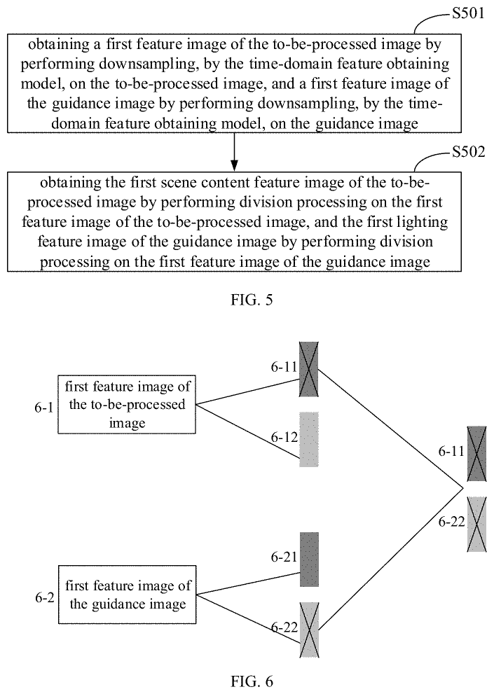

For example, as illustrated in FIG. 6, after downsampling is performed on the to-be-processed image and the guidance image by the time-domain feature obtaining model, the first feature image 6-1 of the to-be-processed image and the first feature image 6-2 of the guidance image may be obtained. Further, the first scene content feature image 6-11 and the first lighting feature image 6-12 of the to-be-processed image 6-1, and the first scene content feature image 6-21 and the first lighting feature image 6-22 of the guidance image 6-2 may be obtained by division processing. In this case, the first scene content feature image 6-11 and the first lighting feature image 6-22 may be obtained. In addition, in an embodiment, the division processing may be performed according to a feature type, feature amount or feature data volume of an image. For example, the division may be performed equally.

At block S402, a merged feature image is obtained by merging the first scene content feature image and the first lighting feature image.

In embodiments of the present disclosure, the first scene content feature image and the first lighting feature image may be spliced in the channel dimension to obtain the merged feature image.

At block S403, the first intermediate image is generated based on the merged feature image.

In embodiments of the present disclosure, upsampling processing may be performed on the merged feature image to generate the first intermediate image.

It should be noted that in the present disclosure, frequencies and factors of upsampling and downsampling may be set based on an actual situation.

For example, the merged feature image may be downsampled 4 times step by step, with downsampling by a factor of 2 each time and thus downsampling by a factor of 16 in total. Further, a downsampled image may be upsampled four times step by step, with upsampling by a factor of 2 each time and thus upsampling by a factor of 16 in total, to obtain the first intermediate image. It should be noted that, during sampling the merged feature image, a size of an obtained feature image should be kept consistent with a size of the merged feature image.

At block S303, a second intermediate image consistent with the illumination condition in the guidance image is obtained by performing relighting rendering on the to-be-processed image in a frequency domain based on the guidance image.

At block S304, a target relighted image corresponding to the to-be-processed image is obtained based on the first intermediate image and the second intermediate image.

The description at blocks S303-S304 is the same as that at blocks S103-S104, which is not elaborated herein.

With the method for generating the relighted image according to embodiments of the present disclosure, the first intermediate image consistent with the illumination condition in the guidance image is obtained by inputting the to-be-processed image and the guidance image into the time-domain feature obtaining model in the relighted image generation system for relighting rendering in the time domain, such that a more accurate first intermediate image is obtained by performing relighting rendering on the to-be-processed image and the guidance image in the time domain and based on the feature information in the time domain, thereby improving a rendering effect of the target relighted image.

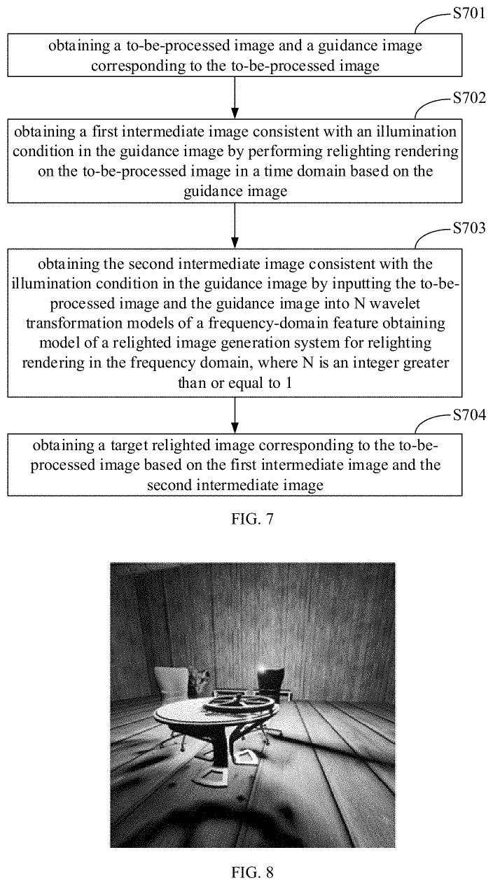

FIG. 7 is a flow chart of a method for generating a relighted image according to a further embodiment of the present disclosure.

As illustrated in FIG. 7, the method for generating the relighted image according to embodiments includes the following operations.

At block S701, a to-be-processed image and a guidance image corresponding to the to-be-processed image are obtained.

At block S702, a first intermediate image consistent with an illumination condition in the guidance image is obtained by performing relighting rendering on the to-be-processed image in a time domain based on the guidance image.

The description at blocks S701-S702 is the same as that at blocks S101-S102 in the above embodiments, which is not elaborated herein.

The operation of obtaining the second intermediate image consistent with the illumination condition in the guidance image by performing relighting rendering on the to-be-processed image in the frequency domain based on the guidance image at block S103 in the above embodiments includes the following operation at block S703.

At block S703, the second intermediate image consistent with the illumination condition in the guidance image is obtained by inputting the to-be-processed image and the guidance image into N wavelet transformation models of a frequency-domain feature obtaining model in a relighted image generation system for relighting rendering in the frequency domain. N is an integer greater than or equal to 1.

The relighted image generation system includes the N wavelet transformation models, where N is an integer greater than or equal to 1. For example, the relighted image generation system includes one wavelet transformation model. For another example, the relighted image generation system includes three wavelet transformation models with a same structure. In this case, the three wavelet transformation models are connected in cascade.

It should be noted that, a type of the wavelet transformation model is not limited in the present disclosure, which may be selected based on an actual situation. Optionally, a discrete wavelet transformation model may be selected to perform relighting rendering on the to-be-processed image.

A brief description of a processing procedure of the wavelet transformation model involved in the method of the present disclosure will be made below.

A frequency value of an image indicates a grayscale change degree in the image, and is a gray scale gradient in a plane space.

For example, for a large-area desert image, a grayscale of the area of the image changes slowly which corresponds to a low frequency value. For another example, for an image having an edge area with a drastic change in its surface attribute, such as a mountainous area image, a grayscale of the area of the image changes drastically which corresponds a high frequency value.

Therefore, from a physical effect, an image may be transformed from a spatial domain to the frequency domain by wavelet transformation, that is, a gray distribution function of the image is transformed into a frequency distribution function of the image. The frequency distribution function of the image may be transformed into the gray distribution function by inverse transformation.

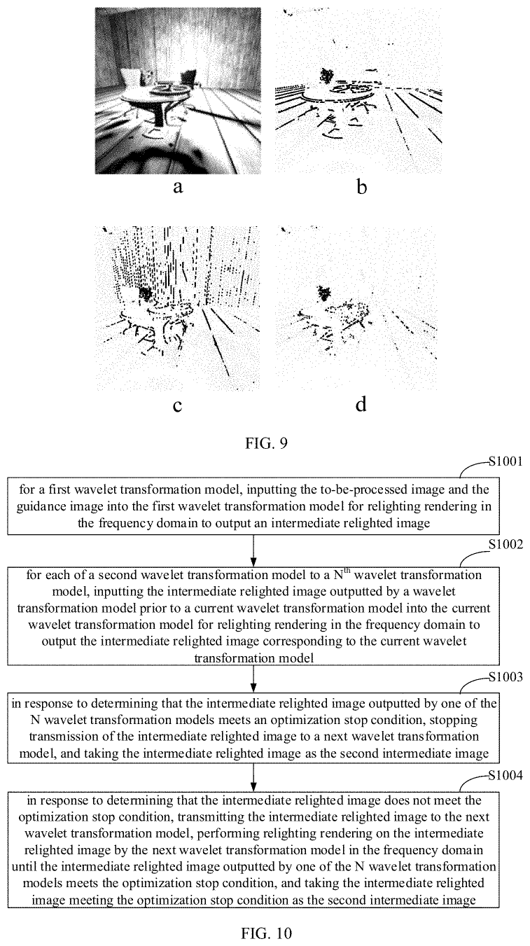

For example, a two-dimensional discrete wavelet transformation model is used for processing the to-be-processed image, such as a to-be-processed image as illustrated in FIG. 8. Optionally, one-dimensional discrete wavelet transformation (DWT) may be performed on each row of pixels of the to-be-processed image to obtain a low-frequency component L and a high-frequency component H of an original image (i.e., the to-be-processed image) in a horizontal direction. Further, one-dimensional DWT may be performed on each column of pixels of transformed data to obtain four results as illustrated in FIG. 9.

As shown in FIG. 9, an image (a) may be obtained based on the low-frequency component in the horizontal direction and a low-frequency component in a vertical direction, i.e., LL, an image (b) may be obtained based on the low-frequency component in the horizontal direction and a high-frequency component in the vertical direction, i.e., LH, an image (c) may be obtained based on the high-frequency component in the horizontal direction and the low-frequency component in the vertical direction, i.e., HL, and an image (d) may be obtained based on the high-frequency component in the horizontal direction and a high-frequency component in the vertical direction, i.e., HH.

In this case, for the to-be-processed image illustrated in FIG. 8, an image reflecting a placement of objects in the to-be-processed image, i.e., the image (a) as illustrated in FIG. 9 may be obtained, which is an approximate image of the to-be-processed image. The image (a) illustrated in FIG. 9 corresponds to a low-frequency part of the to-be-processed image. The three images (b)-(d) illustrated in FIG. 9 correspond to outline of the to-be-processed image, which are detailed images in the horizontal, vertical and diagonal directions, respectively. The three images correspond to a high-frequency part of the to-be-processed image.

In embodiments of the present disclosure, in a case that both a width and a height of the to-be-processed image inputted are 1024 and the number of channels is 3, a size of the to-be-processed image may be expressed as 1024*1024*3. Optionally, after the to-be-processed image is subjected to the DWT processing by the discrete wavelet transformation network in the discrete wavelet transformation model, a size is changed as 512*512*3.

Further, by concatenating the four images (a)-(d) in FIG. 9 in the channel dimension, an image with a size of 512*512*12 may be obtained. In this case, after DWT processing, both the width and the height of the to-be-processed image are reduced by a factor of 2 while the number of channels is increased by a factor of 4. This procedure is also called a conversion process from space to depth (Spatial2Depth).

Therefore, the wavelet transformation may replace operation of maximum pooling or average pooling commonly used in the CNN, such that the whole to-be-processed image may be converted by the DWT processing instead of merely local conversion, with advantages of larger receptive field and wider processing area, thus improving the accordance of the processed result.

Further, after processing the to-be-processed image by the wavelet transform network in the wavelet transformation model, optionally, inverse discrete wavelet transformation (IDWT) may be performed on the processed image by an inverse discrete wavelet transformation network in the discrete wavelet transformation model. A process of the inverse discrete wavelet transformation is similar to the DWT processing, which is not elaborated here.

It should be noted that, in the present disclosure, in order to further improve a rendering effect and reliability of the relighted image, the relighted image generation system having at least two cascaded wavelet transformation models may be employed.

In an embodiment, N is an integer greater than 1. As illustrated in FIG. 10, the method specifically includes the following operations on the basis of the above embodiments.

At block S1001, for a first wavelet transformation model, the to-be-processed image and the guidance image are inputted into the first wavelet transformation model for relighting rendering in the frequency domain to output an intermediate relighted image.

In embodiments of the present disclosure, a multi-stage rendering strategy may be employed. That is, for the first wavelet transformation model, the to-be-processed image and the guidance image are inputted into the first wavelet transformation model for relighting rendering to output the intermediate relighted image, and a mapping relationship among the to-be-processed image, the guidance image, and the intermediate relighted image outputted is learned.

It should be noted that, in a model training stage, for the first wavelet transformation model, the to-be-processed image and the guidance image are inputted into the first wavelet transformation model for relighting rendering, and the intermediate relighted image is outputted. After these, the first wavelet transformation model may be determined. A training set (a preset number of to-be-processed sample images and guidance images) may be processed by the first wavelet transformation model, and intermediate relighted images of the training set processed by the first wavelet transformation model may be outputted.

At block S1002, for each of a second wavelet transformation model to a N^{th} wavelet transformation model, the intermediate relighted image outputted by a wavelet transformation model prior to a current wavelet transformation model is input into the current wavelet transformation model for relighting rendering in the frequency domain to output the intermediate relighted image corresponding to the current wavelet transformation model.

In embodiments of the present disclosure, from the second wavelet transformation model, the intermediate relighted image outputted by the upper wavelet transformation model may be inputted into the current wavelet transformation model for relighting rendering to output the intermediate relighted image corresponding to the current wavelet transformation model. In this case, since most mapping relationships have been learned by the upper wavelet transformation model, the intermediate relighted image corresponding to the current wavelet transformation model is closer to a ground truth than the intermediate relighted image corresponding to the upper wavelet transformation model. At the same time, in the model training stage, a training difficulty of the following wavelet transformation model may be greatly reduced.

At block S1003, in response to determining that the intermediate relighted image outputted by one of the N wavelet transformation models meets an optimization stop condition, transmission of the intermediate relighted image to a next wavelet transformation model is stopped, and the intermediate relighted image is taken as the second intermediate image.

The optimization stop condition may be set based on an actual situation, which is not limited in the present disclosure.

Optionally, the optimization stop condition may be set as the number of wavelet transformation models for image processing. Optionally, the optimization stop condition may be set as a rendering effect of the intermediate relighted image.

For example, the optimization stop condition is that the number of wavelet transformation models for image processing is 2. If an intermediate relighted image outputted by a wavelet transformation model is an image obtained and processed by the second wavelet transformation model, the intermediate relighted image meets the optimization stop condition. Then the transmission of the intermediate relighted image to a next wavelet transformation model is stopped, and the intermediate relighted image is taken as the second relighted image.

At block S1004, in response to determining that the intermediate relighted image does not meet the optimization stop condition, the intermediate relighted image is transmitted to the next wavelet transformation model, relighting rendering is performed on the intermediate relighted image by the next wavelet transformation model in the frequency domain until the intermediate relighted image outputted by one of the N wavelet transformation models meets the optimization stop condition. The intermediate relighted image meeting the optimization stop condition is taken as the second intermediate image.

For example, the optimization stop condition is that the number of wavelet transformation models for image processing is 3. In this case, if an intermediate relighted image outputted by a wavelet transformation model is an image obtained and processed by the second wavelet transformation model, the intermediate relighted image does not meet the optimization stop condition. Then the intermediate relighted image may be transmitted to the third wavelet transformation model continuously for relighting rendering, and the intermediate relighted image outputted by the third wavelet transformation model is taken as the target relighted image.

At block S704, a target relighted image corresponding to the to-be-processed image is obtained based on the first intermediate image and the second intermediate image.

Description at block S704 is the same as that at block S104 in the above embodiments, which is not elaborated herein.

With the method for generating the relighted image according to embodiments of the present disclosure, the second intermediate image consistent with the illumination condition in the guidance image is obtained by inputting the to-be-processed image and the guidance image into the frequency-domain feature obtaining model of the relighted image generation system for relighting rendering in the frequency domain, such that a more accurate second intermediate image is obtained by relighting rendering on the to-be-processed image and the guidance image in the frequency domain and based on the feature information in the frequency domain, thereby improving the rendering effect of the target relighted image.

It should be noted that, in the present disclosure, a residual network (also referred as Res. Block) and a skip connection may be introduced in the processing of downsampling and upsampling to improve the rendering effect of the target relighted image.

In an embodiment, as illustrated in FIG. 11, in the method for generating the relighted image according to the present disclosure, based on the above embodiments, relighting rendering performed on an image by one of the N wavelet transformation models may specifically include the followings operations.

At block S1101, the image is inputted into a wavelet transformation network of the one of the N wavelet transformation models, downsampling is performed on the image by the one of the N wavelet transformation network, and a second scene content feature image and a second lighting feature image corresponding to the image are outputted by the wavelet transformation network.

At block S1102, the second scene content feature image and the second lighting feature image are inputted into a residual network of the one of the N wavelet transformation models, the second scene content feature image and the second lighting feature image are reconstructed by the residual network, and a reconstructed feature image is outputted.

At block S1103, the reconstructed feature image is inputted into a wavelet inverse transformation network of the one of the wavelet transformation models, and an upsampled feature image is outputted.

In embodiments of the present disclosure, downsampling may be performed on one image to obtain a feature image corresponding to the image. Then upsampling is performed on the reconstructed feature image obtained from the residual network reconstruction to obtain the upsampled feature image. A frequency and a factor of downsampling are the same as those of upsampling. The frequencies and the factors of upsampling and downsampling may be set based on an actual situation.

For example, the image may be downsampled 4 times step by step, with downsampling by a factor of 2 each time, that is, downsampling by a factor of 16 in total, to obtain the feature image corresponding to the image. Further, the reconstructed feature image may be upsampled four times step by step, with upsampling by a factor of 2 each time, that is, upsampling by a factor of 16 in total, to obtain the upsampled feature image. It should be noted that, during sampling the image, a size of the feature image obtained should be kept consistent with a size of the image.

With the method for generating the relighted image according to embodiments of the present disclosure, the residual network and the skip connection are introduced into the wavelet transformation model, such that an input of upsampling is based on an output of an upper upsampling and in combination with an corresponding output of downsampling, thereby playing a supervisory role during relighting rendering, preventing learning errors, and further improving the rendering effect and reliability of the relighted image outputted.

It should be noted that, in the present disclosure, a local convolution-normalization-nonlinearity network (Conv-IN-Relu) is introduced to the relighted image generation system to further process the feature image obtained.

Optionally, preprocessing may be performed only for the image obtained from downsampling. Optionally, preprocessing may only be performed on the image obtained from upsampling. Optionally, preprocessing may be performed on the image obtained from downsampling and the image obtained from upsampling, respectively.

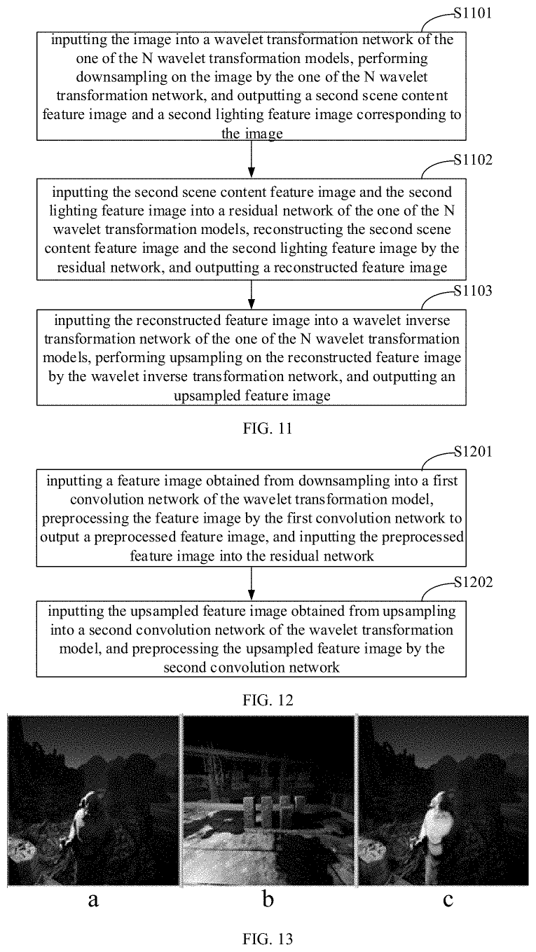

In an embodiment, as illustrated in FIG. 12, on the basis of the above embodiments, preprocessing the image obtained from downsampling and the image obtained from upsampling includes the following operations at block S1201 and at block S1202, respectively.

At block S1201, a feature image obtained from downsampling is inputted into a first convolution network of the wavelet transformation model, the feature image is preprocessed by the first convolution network to output a preprocessed feature image, and the preprocessed feature image is inputted into the residual network.

At block S1202, the upsampled feature image obtained from upsampling is inputted into a second convolution network of the wavelet transformation model, and the upsampled feature image is preprocessed by the second convolution network.

Preprocessing the feature image includes processes such as convolution, normalization, and activation on the image. The preprocessed feature image integrates local information of the original feature image and increases nonlinearity.

With the method for generating the relighted image according to embodiments of the present disclosure, by image preprocessing, the network is deepened, the learning ability and fitting ability of the wavelet transformation model are enhanced, and the rendering effect and reliability of the relighted image outputted are further improved.

It should be noted that, the method for generating the relighted image according to the present disclosure may be applied to various image processing scenes.

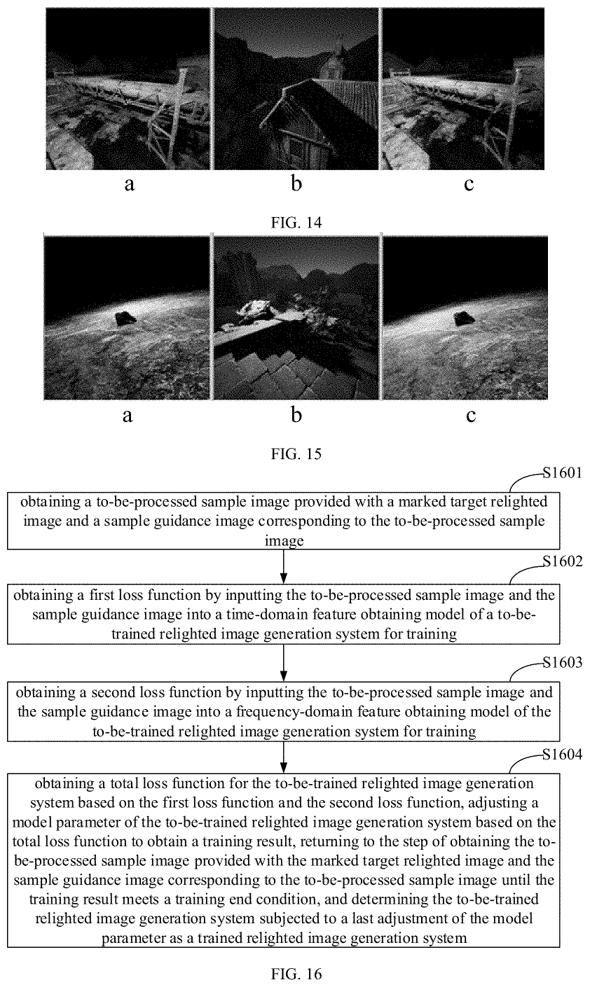

For an application scene where a filter is added to an ordinary scene image, as illustrated in FIG. 13 and FIG. 14, the to-be-processed image may be rendered in accordance with filter effects in the different guidance images, to change the illumination condition of the to-be-processed image to create different filter effects. In this way, a user may obtain various results with different tones for one image captured, which is convenient for the user to performing subsequent process such as editing, thus improving user's experience and attracting interest of the user.

For example, as illustrated in FIG. 13, a target relighted image (c) may be obtained by rendering a to-be-processed image (a) by the relighted image generation system according to a guidance image (b).

For another example, as illustrated in FIG. 14, a target relighted image (c) may be obtained by rendering a to-be-processed image (a) by the relighted image generation system based on a guidance image (b).

For an application scene where a special effect is added to a human image, as illustrated in FIG. 15, various effects may be generated by changing darkness degree and position of shadows, thereby adding a new gameplay to attract the user to use the product.

For example, as illustrated in FIG. 15, a target relighted image (c) may be obtained by rendering a to-be-processed image (a) by the relighted image generation system based on a guidance image (b).

In conclusion, with the method for generating the relighted image according to the present disclosure, after an image (i.e., the to-be-processed) is inputted, a corresponding guidance image is provided to generate a result image (i.e., the target relighted image) consistent with the illumination condition in the guidance image. In this way, it is not required to know changes of an illumination direction and a color temperature from the image to the result image.

FIG. 16 is a flow chart of a method for training a relighted image generation system according to an embodiment of the present disclosure. It should be noted that, an executive subject of a method for training a relighted image generation system according to embodiments is an apparatus for training a relighted image generation system. The apparatus for training the relighted image generation system may be a hardware device, or software in the hardware device. The hardware device may be such as a terminal device or a server.

As illustrated in FIG. 16, the method for training the relighted image generation system according to embodiments includes the following operations.

At block S1601, a to-be-processed sample image provided with a marked target relighted image and a sample guidance image corresponding to the to-be-processed sample image are obtained.

The to-be-processed sample image and the sample guidance image are the same in quantity, which may be determined according to the actual situations. For example, 1000 couples of the to-be-processed sample images and the corresponding sample guidance images are obtained.

At block S1602, a first loss function is obtained by inputting the to-be-processed sample image and the sample guidance image into a time-domain feature obtaining model of a to-be-trained relighted image generation system for training.

At block S1603, a second loss function is obtained by inputting the to-be-processed sample image and the sample guidance image into a frequency-domain feature obtaining model of the to-be-trained relighted image generation system for training.

At block S1604, a total loss function for the to-be-trained relighted image generation system is obtained based on the first loss function and the second loss function, a model parameter of the to-be-trained relighted image generation system is adjusted based on the total loss function to obtain a training result, it returns to the step of obtaining the to-be-processed sample image provided with the marked target relighted image and the sample guidance image corresponding to the to-be-processed sample image until the training result meets a training end condition, and the to-be-trained relighted image generation system subjected to a last adjustment of the model parameter is determined as a trained relighted image generation system.

The training end condition may be set based on the actual situation, which is not limited in the present disclosure.

Optionally, the training end condition may be set as a rendering effect of the target relighted image outputted by the to-be-trained relighted image generation system. For example, the training end condition may be set as a difference between the target relighted image outputted by the to-be-trained relighted image generation system and the marked target relighted image.

With the method for training the relighted image generation system according to embodiments of the present disclosure, the model parameter in the to-be-trained relighted image generation system may be adjusted based on the first and second loss functions until the training result meets the training end condition, and the to-be-trained relighted image generation system subjected to the last adjustment of the model parameter is determined as the trained relighted image generation system, thereby improving the training effect of the relighted image generation system, and laying a foundation for accurately obtaining the relighted image based on any relighting technology.

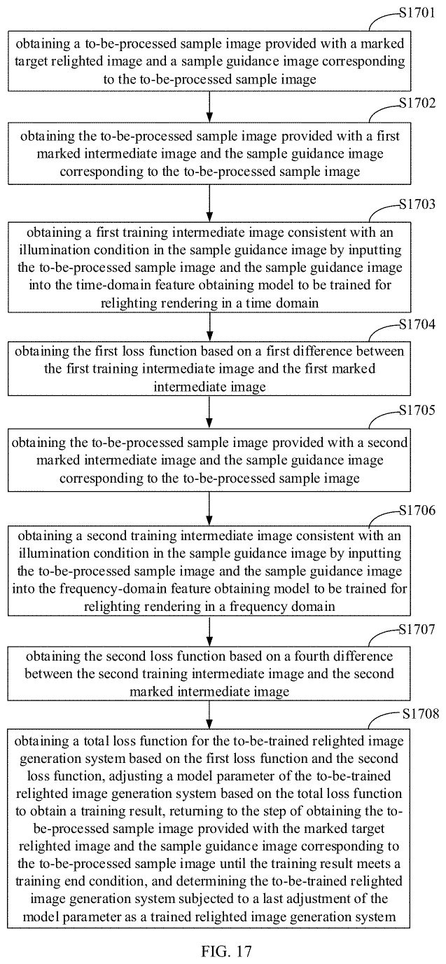

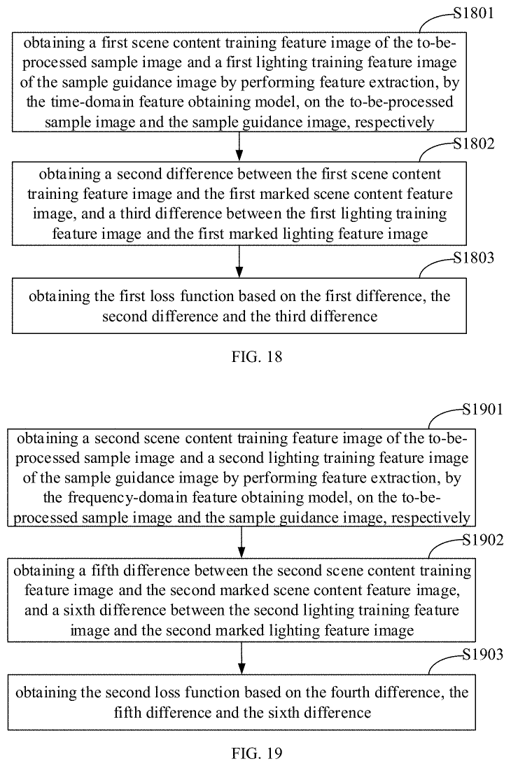

FIG. 17 is a flow chart of a method for training a relighted image generation system according to another embodiment of the present disclosure.

As illustrated in FIG. 17, the method for training the relighted image generation system according to embodiments includes the following operations.

At block S1701, a to-be-processed sample image provided with a marked target relighted image and a sample guidance image corresponding to the to-be-processed sample image are obtained.

Description at block S1701 is the same as that at block S1601 in the above embodiment, which is not elaborated herein.

The operation of obtaining the first loss function of the time-domain model by inputting the sample image and the sample guidance image into the time-domain feature obtaining model of the to-be-trained relighted image generation system for training at block S1602 in the above embodiment includes the following operations at blocks S1702-1704.

At block S1702, the to-be-processed sample image provided with a first marked intermediate image and the sample guidance image corresponding to the to-be-processed sample image are obtained.

At block S1703, a first training intermediate image consistent with an illumination condition in the sample guidance image is obtained by inputting the to-be-processed sample image and the sample guidance image into the time-domain feature obtaining model to be trained for relighting rendering in a time domain.

At block S1704, the first loss function is obtained based on a first difference between the first training intermediate image and the first marked intermediate image.

In an embodiment, as illustrated in FIG. 8, the to-be-processed sample image includes a first marked scene content feature image predicted by a first classifier and a first marked lighting feature image predicted by a second classifier. The operation of obtaining the first loss function based on the first difference between the first training intermediate image and the first marked intermediate image at block S1704 includes the following operations.

At block S1801, a first scene content training feature image of the to-be-processed sample image and a first lighting training feature image of the sample guidance image are obtained by performing feature extraction, by the time-domain feature obtaining model, on the to-be-processed sample image and the sample guidance image, respectively.

At block S1802, a second difference between the first scene content training feature image and the first marked scene content feature image, and a third difference between the first lighting training feature image and the first marked lighting feature image are obtained.

At block S1803, the first loss function is obtained based on the first difference, the second difference and the third difference.

The operation of obtaining the second loss function by inputting the to-be-processed sample image and the sample guidance image into the frequency-domain feature obtaining model of the to-be-trained relighted image generation system for training at block S1603 in the above embodiments includes the following operations at blocks S1705-1707.

At blocks S1705, the to-be-processed sample image provided with a second marked intermediate image and the sample guidance image corresponding to the to-be-processed sample image are obtained.

At blocks S1706, a second training intermediate image consistent with an illumination condition in the sample guidance image is obtained by inputting the to-be-processed sample image and the second sample guidance image into the frequency-domain feature obtaining model to be trained for relighting rendering in a frequency domain.

At blocks S1707, the second loss function is obtained based on a fourth difference between the second training intermediate image and the second marked intermediate image.

In an embodiment, as illustrated in FIG. 19, the to-be-processed sample image includes a second marked scene content feature image predicted by a first classifier and a second marked lighting feature image predicted by a second classifier. On the basis of the above embodiments, the operation of obtaining the second loss function based on the fourth difference between the second training intermediate image and the second marked intermediate image at block S1707 includes the following operations.

At block S1901, a second scene content training feature image of the to-be-processed sample image and a second lighting training feature image of the sample guidance image are obtained by performing feature extraction, by the frequency-domain feature obtaining model, on the to-be-processed sample image and the sample guidance image, respectively.

At block S1902, a fifth difference between the second scene content training feature image and the second marked scene content feature image, and a sixth difference between the second lighting training feature image and the second marked lighting feature image are obtained.

At block S1903, the second loss function is obtained based on the fourth difference, the fifth difference and the sixth difference.

At block S1708, a total loss function for the to-be-trained relighted image generation system is obtained based on the first loss function and the second loss function, a model parameter of the to-be-trained relighted image generation system is adjusted based on the total loss function to obtain a training result, it returns to the step of obtaining the to-be-processed sample image provided with the marked target relighted image and the sample guidance image corresponding to the to-be-processed sample image until the training result meets a training end condition, and the to-be-trained relighted image generation system subjected to a last adjustment of the model parameter is determined as a trained relighted image generation system.

In the embodiments of the present disclosure, obtaining, storage, application and the like of personal information of the user comply with the provisions of relevant laws and regulations, and do not violate public order and good customs.

Embodiments of the present disclosure also provide an apparatus for generating a relighted image corresponding to the method for generating the relighted image according to the above embodiments. Since the apparatus for generating the relighted image according to embodiments of the present disclosure corresponds to the method for generating the relighted image according to the above embodiments, the implementation of the method for generating the relighted image is also applicable to the apparatus for generating the relighted image according to embodiments, which is not described in detail in embodiments.

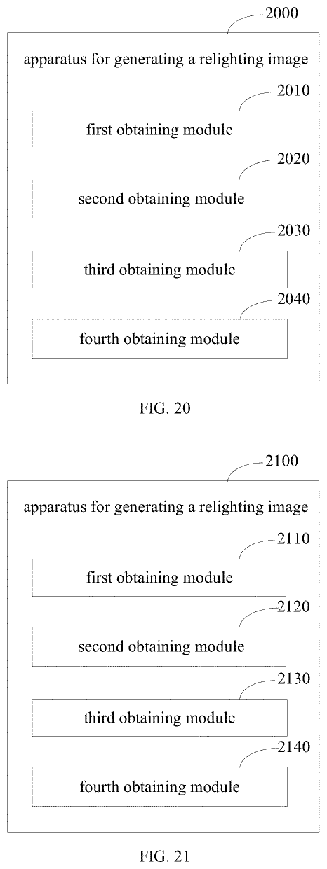

FIG. 20 is a block diagram illustrating an apparatus for generating a relighted image according to an embodiment of the present disclosure.

As illustrated in FIG. 20, the apparatus 2000 for generating a relighted image includes: a first obtaining module 2010, a second obtaining module 2020, a third obtaining module 2030, and a fourth obtaining module 2040.

The first obtaining module is configured to obtain a to-be-processed image and a guidance image corresponding to the to-be-processed image. The second obtaining module is configured to obtain a first intermediate image consistent with an illumination condition in the guidance image by performing relighting rendering on the to-be-processed image in a time domain based on the guidance image. The third obtaining module is configured to obtain a second intermediate image consistent with the illumination condition in the guidance image by performing relighting rendering on the to-be-processed image in a frequency domain based on the guidance image. The fourth obtaining module is configured to obtain a target relighted image corresponding to the to-be-processed image based on the first intermediate image and the second intermediate image.

FIG. 21 is a block diagram illustrating an apparatus for generating a relighted image according to another embodiments of the present disclosure.

As illustrated in FIG. 21, the apparatus 2100 for generating a relighted image includes: a first obtaining module 2110, a second obtaining module 2120, a third obtaining module 2130, and a fourth obtaining module 2140.

The second obtaining module 2120 is further configured to: obtain the first intermediate image consistent with the illumination condition in the guidance image by inputting the to-be-processed image and the guidance image into a time-domain feature obtaining model of a relighted image generation system for relighting rendering in the time domain.

The second obtaining module 2120 is further configured to: obtain a first scene content feature image of the to-be-processed image and a first lighting feature image of the guidance image by performing feature extraction, by the time-domain feature obtaining model, on the to-be-processed image and the guidance image; obtain a merged feature image by merging the first scene content feature image and the first lighting feature image; and generate the first intermediate image based on the merged feature image.

The second obtaining module 2120 is further configured to: obtain a first feature image of the to-be-processed image and a first feature image of the guidance image by performing downsampling, by the time-domain feature obtaining model, on the to-be-processed image and the guidance image, respectively; and obtain the first scene content feature image of the to-be-processed image and the first lighting feature image of the guidance image by performing division processing on the first feature image of the to-be-processed image and the first feature image of the guidance image, respectively.

The second obtaining module 2120 is further configured to: generate the first intermediate image by performing upsampling on the merged feature image.

The third obtaining module 2130 is further configured to: obtain the second intermediate image consistent with the illumination condition in the guidance image by inputting the to-be-processed image and the guidance image into N wavelet transformation models of a frequency-domain feature obtaining model of a relighted image generation system for relighting rendering in the frequency domain. N is an integer greater than or equal to 1.

N is an integer greater than 1, and the third obtaining module 2130 is further configured to: for a first wavelet transformation model, input the to-be-processed image and the guidance image into the first wavelet transformation model for relighting rendering in the frequency domain to output an intermediate relighted image; for each of a second wavelet transformation model to a Nth wavelet transformation model, input the intermediate relighted image outputted by a wavelet transformation model prior to a current wavelet transformation model into the current wavelet transformation model for relighting rendering in the frequency domain to output the intermediate relighted image corresponding to the current wavelet transformation model; and in response to determining that the intermediate relighted image outputted by one of the N wavelet transformation models meets an optimization stop condition, stop transmission of the intermediate relighted image to a next wavelet transformation model, and take the intermediate relighted image as the second intermediate image.

The third obtaining module 2130 is further configured to: in response to determining that the intermediate relighted image does not meet the optimization stop condition, transmit the intermediate relighted image to the next wavelet transformation model, perform relighting rendering on the intermediate relighted image by the next wavelet transformation model in the frequency domain until the intermediate relighted image outputted by one of the N wavelet transformation models meets the optimization stop condition, and take the intermediate relighted image meeting the optimization stop condition as the second intermediate image.

The third obtaining module 2130 is further configured to: input an image comprising the to-be-processed image, the guidance image and the intermediate relighted image into a wavelet transformation network of one of the N wavelet transformation models, perform downsampling on the image by the one of the N wavelet transformation networks, and output a second scene content feature image and a second lighting feature image corresponding to the image; input the second scene content feature image and the second lighting feature image into a residual network of the one of the N wavelet transformation models, reconstruct the second scene content feature image and the second lighting feature image by the residual network, and output a reconstructed feature image by the residual network; and input the reconstructed feature image into a wavelet inverse transformation network of the one of the N wavelet transformation models, perform upsampling on the reconstructed feature image by the wavelet inverse transformation network, and output an upsampled feature image.

The third obtaining module 2130 is further configured to: obtain a second feature image of the to-be-processed image and a second feature of the guidance image by performing downsampling, by the frequency-domain feature obtaining model, on the to-be-processed image and the guidance image, respectively; and obtain the second scene content feature image of the to-be-processed image and the second lighting feature image of the guidance image by performing division processing on the second feature image of the to-be-processed image and the second feature of the guidance image, respectively.

The third obtaining module 2130 is further configured to: input the second scene content feature image and the second lighting feature image obtained from downsampling into a first convolution network of the wavelet transformation model, preprocess the feature image by the first convolution network to output a preprocessed feature image, and input the preprocessed feature image into the residual network.

The third obtaining module 2130 is further configured to: input the upsampled feature image obtained from upsampling into a second convolution network of the wavelet transformation model, and preprocess the upsampled feature image by the second convolution network.

The fourth obtaining module 2140 is further configured to: obtain a weighted result by performing weighting processing on the first intermediate image and the second intermediate image, obtain a post-processed result by performing post-processing on the weighted result, and take the post-processed result as the target relighted image corresponding to the to-be-processed image.

It should be noted that, the first obtaining module 2110 has the same function and structure as the first obtaining module 2010.

With the apparatus for generating the relighted image according to embodiments of the present disclosure, the relighted image is generated without the manual design or the convolution neural network model obtained according to the neural network learning and training. Relighting rendering is performed on the to-be-processed image and the guidance image in the time domain and in the frequency domain. For the target relighted image obtained from the relighting technology, the scene content structure at the low frequency and detailed shadow information at the high frequency are retained according to feature information in the time domain and in the frequency domain. In this way, the target relighted image with an accurate and reliable rendering effect is realized.

Embodiments of the present disclosure also provide an apparatus for training a relighted image generation system corresponding to the method for training the relighted image generation system according to the above embodiments. Since the apparatus for training the relighted image generation system according to embodiments of the present disclosure corresponds to the method for training the relighted image generation system according to the above embodiments, the implementation of the method for training the relighted image generation system is also applicable to the apparatus for training the relighted image generation system according to embodiments, which is not described in detail in embodiments.

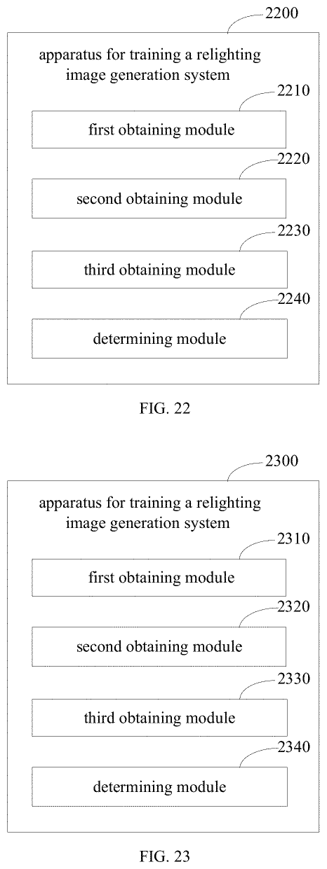

FIG. 22 is a block diagram illustrating an apparatus for training a relighted image generation system according to an embodiment of the present disclosure.

As illustrated in FIG. 22, the apparatus 2200 for training the relighted image generation system includes: a first obtaining module 2210, a second obtaining module 2220, a third obtaining module 2230, and a determining module 2240.

The first obtaining module is configured to obtain a to-be-processed sample image provided with a marked target relighted image and a sample guidance image corresponding to the to-be-processed sample image. The second obtaining module is configured to obtain a first loss function by inputting the to-be-processed sample image and the sample guidance image into a time-domain feature obtaining model of a to-be-trained relighted image generation system for training. The third obtaining module is configured to obtain a second loss function by inputting the to-be-processed sample image and the sample guidance image into a frequency-domain feature obtaining model of the to-be-trained relighted image generation system for training. The determining module is configured to obtain a total loss function for the to-be-trained relighted image generation system based on the first loss function and the second loss function, adjust a model parameter of the to-be-trained relighted image generation system based on the total loss function to obtain a training result, return to the step of obtaining the to-be-processed sample image of the marked target relighted image and the sample guidance image corresponding to the to-be-processed sample image until the training result meets a training end condition, and to determine the to-be-trained relighted image generation system subjected to a last adjustment of the model parameter as a trained relighted image generation system.

FIG. 23 is a block diagram illustrating an apparatus for training a relighted image generation system according to another embodiment of the present disclosure.

As illustrated in FIG. 23, the apparatus 2300 for training the relighted image generation system includes: a first obtaining module 2310, a second obtaining module 2320, a third obtaining module 2330, and a determining module 2340.

The second obtaining module 2320 is further configured to: obtain the to-be-processed sample image provided with a first marked intermediate image and the sample guidance image corresponding to the to-be-processed sample image; obtain a first training intermediate image consistent with an illumination condition in the sample guidance image by inputting the to-be-processed sample image and the sample guidance image into the time-domain feature obtaining model to be trained for relighting rendering in a time domain; and obtain the first loss function based on a first difference between the first training intermediate image and the first marked intermediate image.

The to-be-processed sample image includes a first marked scene content feature image predicted by a first classifier and a first marked lighting feature image predicted by a second classifier. The second obtaining module 2320 is further configured to: obtain a first scene content training feature image of the to-be-processed sample image and a first lighting training feature image of the sample guidance image by performing feature extraction, by the time-domain feature obtaining model, on the to-be-processed sample image and the sample guidance image, respectively; obtain a second difference between the first scene content training feature image and the first marked scene content feature image, and a third difference between the first lighting training feature image and the first marked lighting feature image; and obtain the first loss function based on the first difference, the second difference and the third difference.

The third obtaining module 2330 is further configured to: obtain the to-be-processed sample image provided with a second marked intermediate image and the sample guidance image corresponding to the to-be-processed sample image; obtain a second training intermediate image consistent with an illumination condition in the sample guidance image by inputting the to-be-processed sample image and the sample guidance image into the frequency-domain feature obtaining model for relighting rendering in a frequency domain; and obtain the second loss function based on a fourth difference between the second training intermediate image and the second marked intermediate image.

The to-be-processed sample image includes a marked second scene content feature image predicted by a first classifier and a marked second lighting feature image predicted by a second classifier. The third obtaining module 2330 is further configured to: obtain a second scene content training feature image of the to-be-processed sample image and a second lighting training feature image of the sample guidance image by performing feature extraction, by the frequency-domain feature obtaining model, on the to-be-processed sample image and the sample guidance image, respectively; obtain a fifth difference between the second scene content training feature image and the second marked scene content feature image, and a sixth difference between the second lighting training feature image and the second marked lighting feature image; and obtain the second loss function based on the fourth difference, the fifth difference and the sixth difference.

It should be noted that, the first obtaining module 2310 has the same function and structure as the first obtaining module 2210, and the determining module 2340 has the same function and structure as the determining module 2240.

With the apparatus for training the relighted image generation system according to embodiments of the present disclosure, the model parameter in the to-be-trained relighted image generation system may be adjusted based on the first and second loss functions until the training result meets the training end condition, and the to-be-trained relighted image generation system subjected to the last adjustment of the model parameter is determined as the trained relighted image generation system, thereby improving the training effect of the relighted image generation system, and laying a foundation for accurately obtaining the relighted image based on any relighting technology.

According to embodiments of the present disclosure, the present disclosure further provides an electronic device, a readable storage medium, and a computer program product.

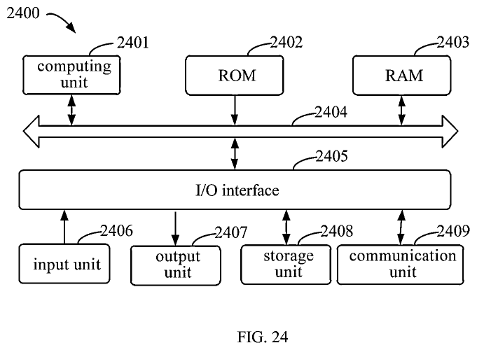

FIG. 24 is a block diagram illustrating an electronic device 2400 according to an embodiment of the present disclosure. The electronic device aims to represent various forms of digital computers, such as a laptop computer, a desktop computer, a workstation, a personal digital assistant, a server, a blade server, a mainframe computer and other suitable computer. The electronic device may also represent various forms of mobile devices, such as personal digital processing, a cellular phone, a smart phone, a wearable device and other similar computing device. The components, connections and relationships of the components, and functions of the components illustrated herein are merely examples, and are not intended to limit the implementation of the present disclosure described and/or claimed herein.

As illustrated in FIG. 24, the device 2400 includes a computing unit 2401. The computing unit 2401 may perform various appropriate actions and processes based on a computer program stored in a read only memory (ROM) 2402 or loaded from a storage unit 2408 into a random access memory (RAM) 2403. In the RAM 2403, various programs and data required for the operation of the device 2400 may also be stored. The computing unit 2401, the ROM 2402, and the RAM 2403 are connected to each other via a bus 2404. An input/output (I/O) interface 2405 is also connected to the bus 2404.

Multiple components in the device 2400 are connected to the I/O interface 2405. The multiple components include an input unit 2406, such as a keyboard, and a mouse; an output unit 2407, such as various types of displays and speakers; a storage unit 2408, such as a magnetic disk, and an optical disk; and a communication unit 2409, such as a network card, a modem, and a wireless communication transceiver. The communication unit 2409 allows the device 2400 to exchange information/data with other devices via a computer network such as the Internet and/or various telecommunication networks.

The computing unit 2401 may be various general-purpose and/or special-purpose processing components with processing and computing capabilities. Some examples of the computing unit 2401 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 2401 performs various methods and processes described above, such as the method for generating the relighted image or the method for training the relighted image generation system. For example, in some embodiments, the method for generating the relighted image or the method for training the relighted image generation system may be implemented as a computer software program tangibly embodied in a machine-readable medium, such as the storage unit 2408. In some embodiments, a part or all of the computer program may be loaded and/or installed on the device 2400 via the ROM 2402 and/or the communication unit 2409. When the computer program is loaded into the RAM 2403 and executed by the computing unit 2401, one or more steps of the method for generating the relighted image or the method for training the relighted image generation system described above may be executed. Alternatively, in other embodiments, the computing unit 2401 may be configured to perform the method for generating the relighted image or the method for training the relighted image generation system by any other suitable means (for example, by means of firmware).

Various implementations of the systems and techniques described above herein may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), computer hardware, firmware, software, and/or a combination thereof. These various implementations may include being implemented in one or more computer programs. The one or more computer programs may be executed and/or interpreted on a programmable system including at least one programmable processor. The programmable processor may be a special purpose or general purpose programmable processor and receive data and instructions from and transmit data and instructions to a storage system, at least one input device, and at least one output device.

The program codes for implementing the method of the present disclosure may be written in any combination of one or more programming languages. These program codes may be provided to a processor or controller of a general purpose computer, a special purpose computer, or other programmable data processing apparatus, such that the program codes, when executed by the processor or controller, cause the functions/operations specified in the flow charts and/or block diagrams to be implemented. The program codes may be executed completely on the machine, partially on the machine, partially on the machine as an independent software package and partially on a remote machine or completely on a remote machine or server.

In the context of the present disclosure, a machine-readable medium may be a tangible medium, which may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, an apparatus, or a device, or any suitable combination of the above. More specific examples of the machine-readable storage medium may include one or more wire-based electrical connections, a portable computer disk, a hard disk, a RAM, a ROM, an erasable programmable read-only memory (EPROM or flash memory), an optical fiber, a portable compact disk read-only memory (CD-ROM), an optical storage device, a magnetic storage device, or any suitable combination of the above.

To provide interaction with a user, the system and technologies described herein may be implemented on a computer. The computer has a display device (such as, a CRT (cathode ray tube) or a LCD (liquid crystal display) monitor) for displaying information to the user, a keyboard and a pointing device (such as, a mouse or a trackball), through which the user may provide the input to the computer. Other types of devices may also be configured to provide interaction with the user. For example, the feedback provided to the user may be any form of sensory feedback (such as, visual feedback, auditory feedback, or tactile feedback), and the input from the user may be received in any form (including acoustic input, voice input or tactile input).

The system and technologies described herein may be implemented in a computing system including a background component (such as, a data server), a computing system including a middleware component (such as, an application server), or a computing system including a front-end component (such as, a user computer having a graphical user interface or a web browser through which the user may interact with embodiments of the system and technologies described herein), or a computing system including any combination of such background component, the middleware components and the front-end component. Components of the system may be connected to each other via digital data communication in any form or medium (such as, a communication network). Examples of the communication network include a local area network (LAN), a wide area networks (WAN), Internet and a block chain network.

The computer system may include a client and a server. The client and the server are generally remote from each other and generally interact via the communication network. A relationship between the client and the server is generated by computer programs operated on a corresponding computer and having a client-server relationship with each other. The server may be a cloud server, a distributed system server or a server combined with a block chain.

The present disclosure further provides a computer program product including a computer program. The computer program is configured to implement the method for generating the relighted image or the method for training the relighted image generation system when executed by the processor.

It should be understood that, steps may be reordered, added or deleted by utilizing flows in the various forms illustrated above. For example, the steps described in the present disclosure may be executed in parallel, sequentially or in different orders, so long as desired results of the technical solution disclosed in the present disclosure may be achieved, there is no limitation here.

The above detailed implementations do not limit the protection scope of the present disclosure. It should be understood by the skilled in the art that various modifications, combinations, sub-combinations and substitutions may be made based on design requirements and other factors. Any modification, equivalent substitution and improvement made within the principle of the present disclosure shall be included in the protection scope of disclosure.

What is claimed is:

1. A method for generating a relighted image, comprising:
obtaining a to-be-processed image and a guidance image corresponding to the to-be-processed image;
obtaining a first intermediate image consistent with an illumination condition in the guidance image by performing relighting rendering on the to-be-processed image in a time domain based on the guidance image;
obtaining a second intermediate image consistent with the illumination condition in the guidance image by performing relighting rendering on the to-be-processed image in a frequency domain based on the guidance image; and
obtaining a target relighted image corresponding to the to-be-processed image based on the first intermediate image and the second intermediate image.

2. The method of claim 1, wherein obtaining the first intermediate image consistent with the illumination condition in the guidance image by performing relighting rendering on the to-be-processed image in the time domain based on the guidance image comprises:
obtaining the first intermediate image consistent with the illumination condition in the guidance image by inputting the to-be-processed image and the guidance image into a time-domain feature obtaining model of a relighted image generation system for relighting rendering in the time domain.

3. The method of claim 2, wherein obtaining the first intermediate image consistent with the illumination condition in the guidance image by inputting the to-be-processed image and the guidance image into the time-domain feature obtaining model of the relighted image generation system for relighting rendering in the time domain comprises:
obtaining a first scene content feature image of the to-be-processed image and a first lighting feature image of the guidance image by performing feature extraction, by the time-domain feature obtaining model, on the to-be-processed image and the guidance image;
obtaining a merged feature image by merging the first scene content feature image and the first lighting feature image; and
generating the first intermediate image based on the merged feature image.

4. The method of claim 3, wherein obtaining the first scene content feature image of the to-be-processed image and the first lighting feature image of the guidance image by performing the feature extraction, by the time-domain feature obtaining model, on the to-be-processed image and the guidance image comprises:
obtaining a first feature image of the to-be-processed image by performing downsampling, by the time-domain feature obtaining model, on the to-be-processed image, and a first feature image of the guidance image by performing downsampling, by the time-domain feature obtaining model, on the guidance image; and
obtaining the first scene content feature image of the to-be-processed image by performing division processing on the first feature image of the to-be-processed image, and the first lighting feature image of the guidance image by performing division processing on the first feature image of the guidance image.

5. The method of claim 3, wherein generating the first intermediate image based on the merged feature image comprises:
generating the first intermediate image by performing upsampling on the merged feature image.

6. The method of claim 1, wherein obtaining the second intermediate image consistent with the illumination condition in the guidance image by performing the relighting rendering on the to-be-processed image in the frequency domain based on the guidance image comprises:
obtaining the second intermediate image consistent with the illumination condition in the guidance image by inputting the to-be-processed image and the guidance image into N wavelet transformation models of a frequency-domain feature obtaining model of a relighted image generation system for relighting rendering in the frequency domain, where N is an integer greater than or equal to 1.

7. The method of claim 6, wherein N is an integer greater than 1, and obtaining the second intermediate image consistent with the illumination condition in the guidance image by inputting the to-be-processed image and the guidance image into the N wavelet transformation models of the frequency-domain feature obtaining model of the relighted image generation system for relighting rendering in the frequency domain comprises:
for a first wavelet transformation model, inputting the to-be-processed image and the guidance image into the first wavelet transformation model for relighting rendering in the frequency domain to output an intermediate relighted image;
for each of a second wavelet transformation model to a N^{th} wavelet transformation model, inputting the intermediate relighted image outputted by a wavelet transformation model prior to a current wavelet transformation model into the current wavelet transformation model for relighting rendering in the frequency domain to output the intermediate relighted image corresponding to the current wavelet transformation model; and
in response to determining that the intermediate relighted image outputted by one of the N wavelet transformation models meets an optimization stop condition, stopping transmission of the intermediate relighted image to a next wavelet transformation model, and taking the intermediate relighted image as the second intermediate image.

8. The method of claim 7, further comprising:
in response to determining that the intermediate relighted image does not meet the optimization stop condition, transmitting the intermediate relighted image to the next wavelet transformation model, performing relighting rendering on the intermediate relighted image by the next wavelet transformation model in the frequency domain until the intermediate relighted image outputted by one of the N wavelet transformation models meets the optimization stop condition, and taking the intermediate relighted image meeting the optimization stop condition as the second intermediate image.

9. The method of claim 6, wherein relighting rendering performed on an image comprising the to-be-processed image, the guidance image and the intermediate relighted image by one of the N wavelet transformation models comprises:
inputting the image into a wavelet transformation network of the one of the N wavelet transformation models, performing downsampling on the image by the one of the N wavelet transformation network, and outputting a second scene content feature image and a second lighting feature image corresponding to the image;
inputting the second scene content feature image and the second lighting feature image into a residual network of the one of the N wavelet transformation models, reconstructing the second scene content feature image and the second lighting feature image by the residual network, and outputting a reconstructed feature image; and
inputting the reconstructed feature image into a wavelet inverse transformation network of the one of the N wavelet transformation models, performing upsampling on the reconstructed feature image by the wavelet inverse transformation network, and outputting an upsampled feature image.

10. The method of claim 9, wherein inputting the image into the wavelet transformation network of the one of the N wavelet transformation models, performing downsampling on the image by the wavelet transformation network, and outputting the second scene content feature image and the second lighting feature image corresponding to the image comprises:
obtaining a second feature image of the to-be-processed image by performing downsampling, by the frequency-domain feature obtaining model, on the to-be-processed image, and a second feature image of the guidance image by performing downsampling, by the frequency-domain feature obtaining model, on the guidance image; and
obtaining the second scene content feature image of the to-be-processed image by performing division processing on the second feature image of the to-be-processed image and the second lighting feature image of the guidance image by performing division processing on the second feature image of the guidance image.

11. The method of claim 9, wherein inputting the second scene content feature image and the second lighting feature image into the residual network of the one of the N wavelet transformation models further comprises:
inputting a feature image obtained from downsampling into a first convolution network of the wavelet transformation model, preprocessing the feature image by the first convolution network to output a preprocessed feature image, and inputting the preprocessed feature image into the residual network.

12. The method of claim 9, further comprising:
inputting the upsampled feature image obtained from upsampling into a second convolution network of the wavelet transformation model, and preprocessing the upsampled feature image by the second convolution network.

13. The method of claim 1, wherein obtaining the target relighted image corresponding to the to-be-processed image based on the first intermediate image and the second intermediate image comprises:
obtaining a weighted result by performing weighting processing on the first intermediate image and the second intermediate image, obtaining a post-processed result by performing post-processing on the weighted result, and taking the post-processed result as the target relighted image corresponding to the to-be-processed image.

14. A method for training a relighted image generation system, comprising:
obtaining a to-be-processed sample image provided with a marked target relighted image and a sample guidance image corresponding to the to-be-processed sample image;
obtaining a first loss function by inputting the to-be-processed sample image and the sample guidance image into a time-domain feature obtaining model of a to-be-trained relighted image generation system for training;
obtaining a second loss function by inputting the to-be-processed sample image and the sample guidance image into a frequency-domain feature obtaining model of the to-be-trained relighted image generation system for training; and
obtaining a total loss function for the to-be-trained relighted image generation system based on the first loss function and the second loss function, adjusting a model parameter of the to-be-trained relighted image generation system based on the total loss function to obtain a training result, returning to the step of obtaining the to-be-processed sample image provided with the marked target relighted image and the sample guidance image corresponding to the to-be-processed sample image until the training result meets a training end condition, and determining the to-be-trained relighted image generation system subjected to a last adjustment of the model parameter as a trained relighted image generation system.

15. The method of claim 14, wherein obtaining the first loss function-by inputting the to-be-processed sample image and the sample guidance image into the time-domain feature obtaining model of the to-be-trained relighted image generation system for training comprises:
obtaining the to-be-processed sample image provided with a first marked intermediate image and the sample guidance image corresponding to the to-be-processed sample image;
obtaining a first training intermediate image consistent with an illumination condition in the sample guidance image by inputting the to-be-processed sample image and the sample guidance image into the time-domain feature obtaining model to be trained for relighting rendering in a time domain; and
obtaining the first loss function based on a first difference between the first training intermediate image and the first marked intermediate image.

16. The method of claim 15, wherein the to-be-processed sample image comprises a first marked scene content feature image predicted by a first classifier and a first marked lighting feature image predicted by a second classifier, and obtaining the first loss function based on the first difference between the first training intermediate image and the first marked intermediate image comprises:
obtaining a first scene content training feature image of the to-be-processed sample image and a first lighting training feature image of the sample guidance image by performing feature extraction, by the time-domain feature obtaining model, on the to-be-processed sample image and the sample guidance image, respectively;
obtaining a second difference between the first scene content training feature image and the first marked scene content feature image, and a third difference between the first lighting training feature image and the first marked lighting feature image; and
obtaining the first loss function based on the first difference, the second difference and the third difference.

17. The method of claim 14, wherein obtaining the second loss function by inputting the to-be-processed sample image and the sample guidance image into the frequency-domain feature obtaining model of the to-be-trained relighted image generation system for training comprises:
obtaining the to-be-processed sample image provided with a second marked intermediate image and the sample guidance image corresponding to the to-be-processed sample image;
obtaining a second training intermediate image consistent with an illumination condition in the sample guidance image by inputting the to-be-processed sample image and the sample guidance image into the frequency-domain feature obtaining model to be trained for relighting rendering in a frequency domain; and
obtaining the second loss function based on a fourth difference between the second training intermediate image and the second marked intermediate image.

18. The method of claim 17, wherein the to-be-processed sample image comprises a second marked scene content feature image predicted by a first classifier and a second marked lighting feature image predicted by a second classifier, and obtaining the second loss function based on the fourth difference between the second training intermediate image and the second marked intermediate image comprises:
obtaining a second scene content training feature image of the to-be-processed sample image and a second lighting training feature image of the sample guidance image by performing feature extraction, by the frequency-domain feature obtaining model, on the to-be-processed sample image and the sample guidance image, respectively;
obtaining a fifth difference between the second scene content training feature image and the second marked scene content feature image, and a sixth difference between the second lighting training feature image and the second marked lighting feature image; and
obtaining the second loss function based on the fourth difference, the fifth difference and the sixth difference.

19. An electronic device, comprising: a processor and a memory, wherein the memory is configured to store executable program codes, and the processor is configured to implement the method for training the relighted image generation system of claim 14 when reading the executable program codes to run a program corresponding to the executable program codes.

20. An electronic device, comprising: a processor and a memory, wherein the memory is configured to store executable program codes, and the processor is configured to implement a method for generating a relighted image when reading the executable program codes to run a program corresponding to the executable program codes, wherein the method comprises:
obtaining a to-be-processed image and a guidance image corresponding to the to-be-processed image;
obtaining a first intermediate image consistent with an illumination condition in the guidance image by performing relighting rendering on the to-be-processed image in a time domain based on the guidance image;
obtaining a second intermediate image consistent with the illumination condition in the guidance image by performing relighting rendering on the to-be-processed image in a frequency domain based on the guidance image; and
obtaining a target relighted image corresponding to the to-be-processed image based on the first intermediate image and the second intermediate image.
